(19) United States
(12) Patent Application Publication
(10) Pub. No.: US 2004/0221972 A1
(43) Pub. Date: Nov. 11, 2004

(54) Flexible sound absorbing banner mounted on a surface

(76) Inventors: Carroll Finley Tomlinson, Charlotte, NC (US); Eric Von Fange, Fort Mill, SC (US)

Correspondence Address: H JAY SPIEGEL, P.O. BOX 444, MOUNT VERNON, VA, 22121, US

(21) Appl. No.: 10/431,443

(22) Filed: May 8, 2003

(51) Int. Cl. E06B 3/04

(52) U.S. Cl. 160/327

(57) ABSTRACT

An improved flexible sound absorbing banner includes a large rectangular flexible sound absorbing material capable of providing for sound absorption in a desired frequency range and structural integrity sufficient to support tension required without damage while permitting application of suitable graphics for desired visual effect. Opposed edges of the banner are clamped between pairs of elongated U-shaped cross-section spreader bars. A smaller dimensioned U-shaped spreader bar is received within a larger dimensioned U-shaped spreader bar and the two spreader bars are clamped together with the edge of the banner clamped between them. First bracket halves are clamped to the spreader bars and second bracket halves are mounted in spaced locations on a wall or ceiling. The first and second bracket halves are interconnected to mount the banner on the wall or ceiling.

### BACKGROUND OF THE INVENTION

The present invention relates to an improved flexible sound absorbing banner mounted on a wall or ceiling surface. The present invention contemplates an improvement over Applicants' invention disclosed and claimed in U.S. Pat. No. 6,386,263, issued May 14, 2002. The entirety of the disclosure of Applicants' prior U.S. Pat. No. 6,386,263 is hereby incorporated by reference herein.

Acoustical treatments designed to absorb and attenuate sound are well known and are embodied in wall treatments, ceiling treatments and floor treatments. In a room or space, it is often desirable to provide acoustical treatments for sound diffusion and sound absorption. Large wall surfaces can be covered with fabric acoustic treatments to great advantage.

A need has, accordingly, developed for a sound absorbing device that can easily be mounted on a wall or ceiling surface to absorb noise in an effective manner while enhancing the appearance of the wall or ceiling. It is with this need in mind that the present invention was developed.

### SUMMARY OF THE INVENTION

The present invention relates to an improved flexible sound absorbing banner mounted on a wall or ceiling surface. The present invention includes the following interrelated objects, aspects and features:

(1) In the preferred embodiment, the present invention includes a large rectangular flexible sound absorbing material, preferably made of fiberglass, and covered with a surface membrane such as NYLON material comprising a banner. The surface membrane may be porous, perforated or non-perforated and impermeable. It should have an appropriate mass layer and sufficient compliance to provide absorptive efficiency across a desired frequency range while having the structural strength to withstand a desired degree of tensioning.

(2) Opposed edges of the banner are clamped between pairs of elongated U-shaped cross-section spreader bars. Each opposed edge is clamped by bending the edge of the banner through four 90° turns. A smaller dimensioned U-shaped spreader bar is receivable within a larger dimensioned U-shaped spreader bar and the two spreader bars may be clamped together with the edge of the banner clamped therebetween.

(3) First bracket halves are attached along the spreader bars.

(4) Second bracket halves are mounted on the wall surface at spaced locations thereon. The spacing between the second bracket halves is specifically chosen so that when the first bracket halves are attached to the second bracket halves, the fabric banner will be stretched to an appropriate degree so that the banner adopts a generally planar configuration extending over the wall surface while hiding the brackets and the spreader bars.

(5) The banner has been found to attenuate and absorb sound waves to an unexpected degree. Through the use of several suspended flexible sound absorbing banners in accordance with the teachings of the present invention, dramatic reduction in reflected noise may be achieved in a room or space.

As such, it is a first object of the present invention to provide an improved flexible sound absorbing banner mounted on a wall surface.

It is a further object of the present invention to provide such a device in which a generally rectangular large fiberglass- sailcloth combination is stretched across a wall perpendicular to the ceiling and floor thereof.

It is a still further object of the present invention to provide such a device in which two spreader bars are provided on each side of the banner and wherein edges of the banner are clamped therebetween.

It is a still further object of the present invention to provide brackets allowing the banner to be stretched into desired configuration over a wall surface.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a side view partially in cross-section depicting the orientation of parts of the device disclosed in Applicants' prior U.S. Pat. No. 6,386,263 when the inventive banner is being assembled.

FIG. 2 shows a view of the assembled banner of Applicants' prior U.S. Pat. No. 6,386,263 with the cables thereof,stretched and with the assembly in its orientation in use.

FIG. 3 shows a side view, partially in cross-section, depicting the present invention during assembly.

FIG. 4 shows a side view, partially in cross-section, of the present invention as installed.

### SPECIFIC DESCRIPTION OF THE PREFERRED EMBODIMENT

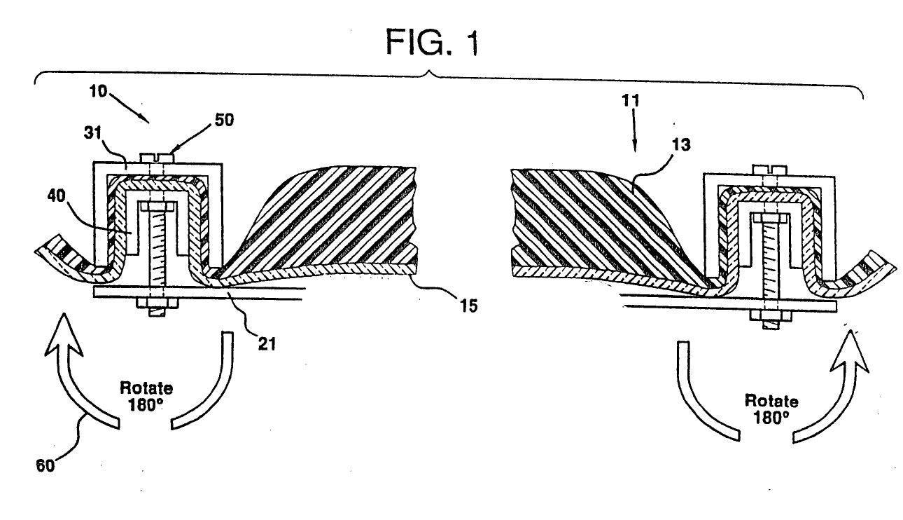

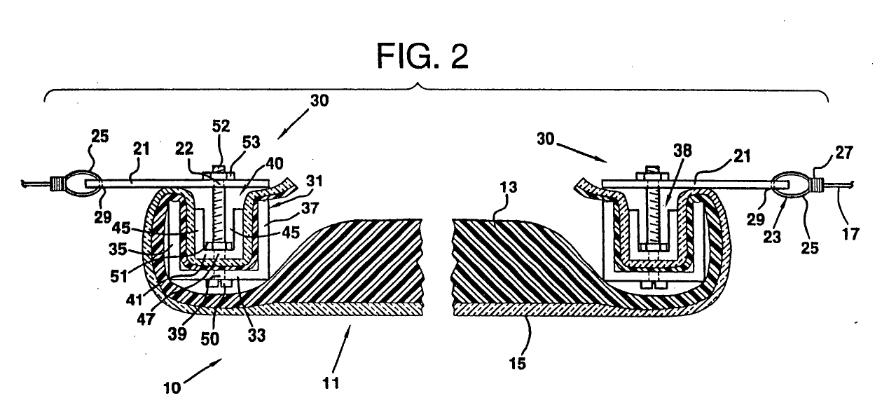

With reference to FIGS. 1 and 2, Applicants' prior invention is generally designated by the reference numeral 10 and is seen to include a large banner of sound absorbent material generally designated by the reference numeral 11 and including a fiberglass bed 13, preferably made of a thickness of approximately two inches and with a density of about 0.75 to 2.0 pounds per cubic foot. The fiberglass bed 13 is covered on one side by a surface membrane protective covering 15, preferably made of a material such as, for example, rip stop NYLON sailcloth. The sailcloth covering 15 may be made with any desired aesthetically pleasing design thereon through any desired process such as, for example, screen printing, graphics, etc.

Tension tabs 21 are attached to the ends of the cables 17. The tension tabs 21 are affixed to the banner 11 in a manner understood with reference to FIGS. 1 and 2.

FIG. 2 shows the configuration of the system 10 in partial cross-section. With reference to FIG. 2, it is seen that the cables 17 are attached to the tension tabs 21 by a connector 23 in the form of a loop 25 with a crimped portion 27 coupling to the cable 17. The loop 25 extends through a pre-formed opening 29 in the tension tab 21 which opening 29 is shown in phantom in FIG. 2.

With further reference to FIG. 2, it is seen that the banner 11 is clamped between clamping means consisting of two clamping assemblies 30. Each clamping assembly includes an outer spreader bar 31 having a U-shaped cross-section including a base 33 and legs 35 and 37 defining an internal chamber 38. The base 33 includes an opening 39 therethrough for a purpose to be described in detail hereinafter.

With further reference to FIG. 2, within the outside spreader bar, an inside spreader bar 40 is provided which has a similar cross-section to that of the inside spreader bar 31 but has smaller dimensions as shown in FIG. 2 so that it fits within chamber 38. The inside spreader bar 40 includes a base 41 and legs 43 and 45. The base 41 has an opening 47 therethrough aligned with the opening 39 in the base 33 of the outside spreader bar 31 and for a purpose to be described in greater detail hereinafter.

As also seen in FIG. 2, the peripheral edge of the banner 11 is inserted within the inner confines of the outer spreader bar 31 and the inner spreader bar 40 is placed over the peripheral edge of the banner 11 in the orientation shown in FIG. 2. A fastening means comprising threaded fastener 50 is inserted through the hole 39 in the base 33 of the outer spreader bar 31, through a hole formed in the banner 11, and through the hole 47 in the base 41 of the inner spreader bar 40. A threaded nut 51 is threaded over the threaded fastener 50 and is tightened to the position shown in FIG. 2 in which the inner spreader bar 40 clamps the peripheral edge of the banner 11 within the recess formed by the outer spreader bar 31.

Thereafter, the tension tab 21 (which is provided with an opening 22) is assembled over the threaded fastener 50 with the opening 22 receiving the end 52 of the threaded fastener 50 and with a further nut 53 threaded over the end 52 of the threaded fastener 50 with the tension tab 21 engaging portions of the peripheral edge of the banner 11 in the manner shown in FIG. 2. The nut 53 is threaded over the end 52 of the threaded fastener 50 and acts as a further clamp clamping the peripheral edge of the banner 11 against the upwardly facing terminations of the legs 35 and 37 of the outside spreader bar 31.

FIG. 1 shows the orientation of parts when they are being assembled together while FIG. 2 shows the orientation of parts in use. With reference to FIG. 1, when the parts are being assembled, the banner 11 is placed flat on a floor surface and the outside spreader bar 31 is placed over the peripheral edge of the banner 11. The inside spreader bar 40 is then installed within the recess formed by the outer spreader bar 31 with the peripheral edge of the banner 11 captured therebetween. The threaded fastener 50 is inserted through the outside and inside spreader bars and through an opening formed in the peripheral edge of the banner 11 and the nut 51 is tightened to clamp the inside spreader bar 40 within the outside spreader bar 31. The threaded fastener 50 then receives the tension tab 21 which is fastened by the nut 53 and the cable 17 is coupled to the tension tab using the loop 25 and the crimped portion 27.

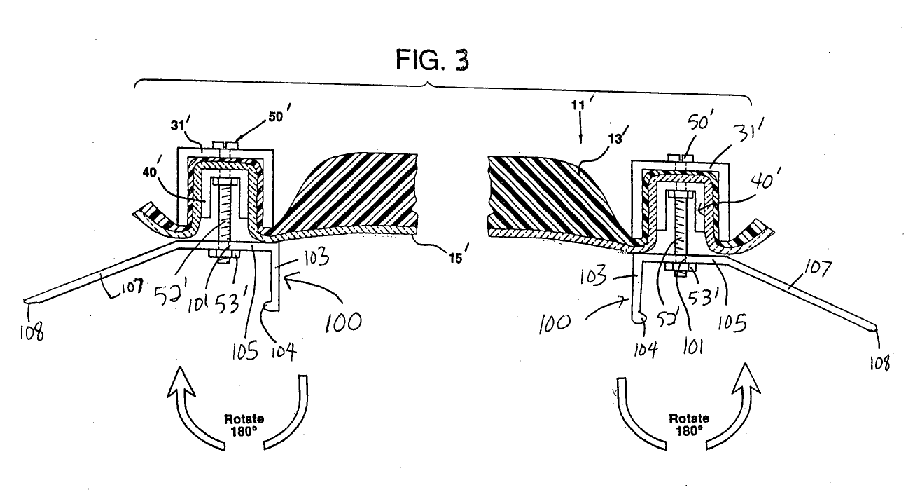

In the position shown in FIG. 1, when the cables 17 are coupled to I-beams (as shown in FIG. 3 of Applicants' prior U.S. Pat. No. 6,386,263), and tightening of the cables 17 begins, the tension tabs rotate in the direction of the arrow 60 (FIG. 1) which causes rotation of the entire clamping assembly including the outside spreader bar 31 and the inside spreader bar 40. When the cables 17 are fully tightened, the rotation will occur over 180° and comparison of FIGS. 1 and 2 shows the tension tabs facing outwardly in FIG. 2 whereas they were facing in the opposite direction, inwardly, in FIG. 1.

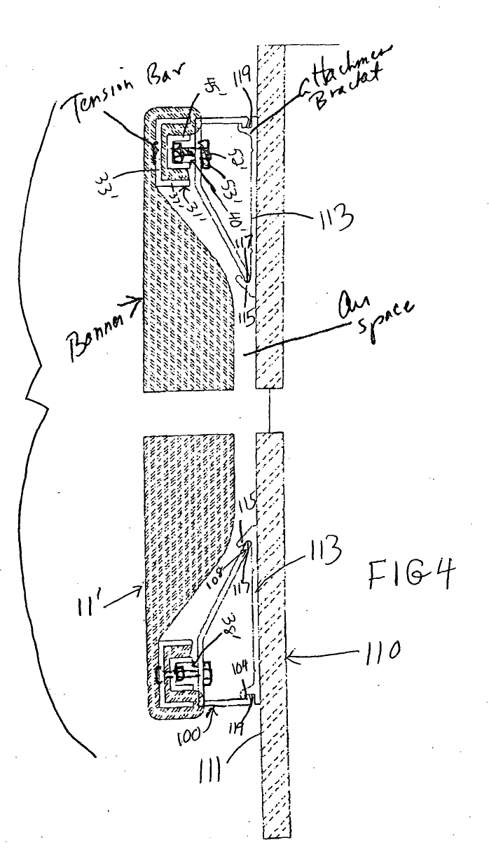

Reference is now made to FIGS. 3 and 4 in which like structures as compared to FIGS. 1 and 2 are described using like primed reference numerals.

The main difference between the present invention and the invention disclosed in Applicants' prior patent as also illustrated in FIGS. 1 and 2 herein consists of the manner of attachment of the banner to a fixed structure. As explained above, in Applicants' prior patent, tension tabs 21 and cables 17 are employed to stretch the banner 11 and retain it in a fixed assembled location. In the present invention, the tension tabs and cables have been replaced with a pair of two piece bracket assemblies.

With reference, first, to FIG. 3, it is seen that first bracket halves 100 are attached to the spreader bars 31′ and 40′ using the bolts 50′ and the nuts 53′. The threaded ends 52′ of the bolts 50′ extend through respective openings 101 formed in the bracket halves 100 and the threaded nuts 53′ are applied in the manner seen in FIG. 3 to affix the bracket halves 100 in the position shown. The bracket halves 100 shown in FIG. 3 extend the length of the spreader bars 31 and 40 into the paper in the view of FIG. 3.

With reference to FIG. 4, a vertical wall (or, alternatively, a ceiling) is designated by the reference numeral 110 and includes a flat surface 111 on which second bracket halves 113 are fastened by any suitable means such as screws or threaded bolts (not shown). The bracket halves 113 are mounted on the wall surface 111 in mirror image with one another and preferably extend the length of the spreader bars 31′ and 40′. See FIG. 3 from Applicants' prior patent which shows the spreader bars 31 and 40 extending the length of the side of the fabric to which they are affixed. Each bracket half 113 includes an outwardly and angularly extending tang 115 at one end thereof defining a recess 117 and, at the other end, a recess 119 that opens in a direction generally parallel. to the surface 111 of the wall 110.

With reference back to FIG. 3, the bracket halves 100 include a first side 103, a second side 105 perpendicular to the first side 103, and a third side 107 that extends at an obtuse angle from the second side 105 and has a terminating end 108. At the end of the first side 103, remote from the second side 105, an inwardly directed tang 104 is provided for a purpose to be described in greater detail hereinafter.

As explained above, the spacing between the bracket halves 113 is chosen so that when the bracket halves 100 are affixed thereto, the banner 11′ will be stretched in an appropriate manner.

With reference to FIG. 3, the bracket halves 100 are seen in their assembled relation with respect to the spreader bars 31′ and 41′.

With reference to FIGS. 3 and 4, in order to mount the fabric banner 11′ on the wall surface 111 (or ceiling), after the bracket halves 113 have been mounted in the appropriate locations, the bracket halves 100 are rotated in the directions of the respective arrows shown in FIG. 3 so that they adopt the positions at orientations shown in FIG. 4. In that position, the upper bracket half 100, in the view of FIG. 4, is mounted on the upper bracket half 113 as shown in FIG. 4. The lower portion of the fabric 11′ is stretched downwardly until the end 108 of the leg 107 and the tang 104 of the leg 103 can be inserted in the recess 117 and the recess 119, respectively, so that the banner 11′ is mounted as shown in FIG. 4.

When it is desired to remove the flexible banner 11′ from the wall surface 111, all that must be done is to grasp the lower edge of the banner 11′ and pull downwardly to release the tang 104 and the end 108 of the bracket half 100 from the recesses 119 and 117, respectively, of the bracket half 113, and then the upper bracket halves may easily be disengaged.

As explained hereinabove, the disclosure of Applicants' prior U.S. Pat. No. 6,386,263 is incorporated by reference herein. The graph of FIG. 4 of Applicants' prior patent is equally applicable to the present invention since the present invention only changes the manner of mounting, not the sound performance of the flexible banner. Thus, the results of Table 1 set forth in Applicants' prior patent are equally applicable as well.

While fiberglass has been described as the preferred sound absorbing material 13′, any suitable sound absorbing material may be employed. Similarly, the surface membrane 15′ may be replaced with any aesthetically pleasing acoustically acceptable material capable of providing an appropriate mass layer, a membrane capable of supporting the required tension, and a surface capable of accepting screen printing and graphics to provide a desired visual effect.

As such, an invention has been disclosed in terms of a preferred embodiment thereof that fulfills each and every one of the objects of the invention as set forth hereinabove and provides a new and useful improved flexible sound absorbing banner mounted on a surface of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A flexible acoustical banner system for releasable mounting on a wall or ceiling, comprising:
a) a flexible banner having spaced side edges;
b) clamping means for clamping about each of said side edges, said clamping means comprising an elongated clamp clamped about each side edge, each clamp having an axis of elongation;
c) a first bracket half attached to each of said clamping means by attaching means for hiding said clamping means while permitting tensioning of said banner, said attaching means comprising a leg of each first bracket half affixed on one of said clamps and rigidly extending laterally of a clamp to which it is affixed;
d) tensioning means for tensioning said banner to stretch said banner, whereby when said banner is tensioned, said side edges are wrapped over said clamps so that said clamps are hidden from view when viewed from said one side of said banner, said tensioning means comprising second bracket halves mounted in spaced locations on said wall or ceiling, said first bracket halves being releasably attached to respective ones of said second bracket halves.

2. The system of claim 1, wherein said banner includes a first layer comprising a sound absorbent material and a second outer layer comprising a membrane having a surface configuration chosen from the group consisting of (1) porous, (2) perforated, and (3) non-perforated impermeable.

3. The system of claim 2, wherein said first layer comprises fiberglass.

4. The system of claim 3, wherein said fiberglass layer has a density in a range of 0.75 to 2.0 lbs./f³.

5. The system of claim 2, wherein said second layer is made of a material chosen from the group consisting of NYLON material or a sound absorptive membrane having a surface chosen from the group consisting of perforated or non-perforated.

6. The system of claim 1, wherein said banner is made of sound absorbent material.

7. The system of claim 1, wherein each of said clamps comprises:
a) a first elongated spreader bar having a U-shaped cross-section and defining an internal chamber;
b) a second elongated spreader bar having a U-shaped cross-section and sized to be received within said chamber;
c) fastening means for connecting said spreader bars together;
d) a said side edge of said banner being clamped between said spreader bars.

8. The system of claim 7, wherein each first bracket half is connected to said spreader bars.

9. The system of claim 8, wherein said fastening means comprises a threaded fastener extending through aligned holes in said spreader bars, said fastener having an enlarged head and a threaded shaft, and a threaded nut received on said shaft.

10. The system of claim 9, wherein each said first bracket half has a hole sized to receive a said threaded shaft and a further threaded nut clamps said first bracket half on said fastener.

11. The system of claim 1, wherein each first bracket half includes a first leg with a tang extending laterally from an open end thereof, a second leg perpendicular to said first leg and a third leg extending obliquely from said second leg and having an end.

12. The system of claim 8, wherein each first bracket half includes a first leg with a tang extending laterally from an open end thereof, a second leg perpendicular to said first leg and a third leg extending obliquely from said second leg and having an end.

13. The system of claim 12, wherein each first bracket half is connected to said spreader bars via said second leg.

14. The system of claim 10, wherein each first bracket half includes a first leg with a tang extending laterally from an open end thereof, a second leg perpendicular to said first leg and a third leg extending obliquely from said second leg and having an end.

15. The system of claim 14, wherein said hole is in said second leg of said first bracket half.

16. The system of claim 11, wherein each second bracket half includes a first recess releasably receiving said tang and a second recess releasably receiving said end of said third leg.

17. The system of claim 1, wherein said banner is made of sound absorbent material.

18. A flexible acoustical banner system for releasable mounting on a wall, comprising:
a) a flexible banner having spaced side edges, said banner including a first layer comprising a sound absorbent fiberglass material and a second layer comprising a sound transparent NYLON material;
b) clamping means for clamping about each of said side edges, said clamping means comprising:
i) a first elongated spreader bar having a U-shaped cross-section and defining an internal chamber;
ii) a second elongated spreader bar having a U-shaped cross-section and sized to be received within said chamber;
iii) fastening means for connecting said spreader bars together;
iv) a said side edge of said banner being clamped between said spreader bars;
c) a first bracket half attached to each of said clamping means by attaching means for hiding said clamping means while permitting tensioning of said banner, said attaching means comprising a leg of each first bracket half affixed on one of said clamps and rigidly extending laterally of a clamp to which it is affixed;
d) tensioning means for tensioning said banner to stretch said banner, whereby when said banner is tensioned, said side edges are wrapped over said clamps so that said clamps are hidden from view when viewed from said one side of said banner, said tensioning means comprising second bracket halves mounted in spaced locations on said wall, said first bracket halves being releasably attached to respective ones of said second bracket halves; and
e) said fastening means comprising a threaded fastener extending through aligned holes in said spreader bars, said fastener having an enlarged head and a threaded shaft, and a threaded nut received on said shaft.

19. The system of claim 18, wherein said fiberglass layer has a density of about 0.75 to 2.0 lbs./f³.

20. The system of claim 18, wherein each first bracket half includes a first leg with a tang extending laterally from an open end thereof, a second leg perpendicular to said first leg and a third leg extending obliquely from said second leg and having an end, and wherein each second bracket half includes a first recess releasably receiving said tang and a second recess releasably receiving said end of said third leg.
